(19) United States
(12) Patent Application Publication
(10) Pub. No.: US 2024/0170733 A1
(43) Pub. Date: May 23, 2024

(54) NON-AQUEOUS ELECTROLYTIC SOLUTION SECONDARY BATTERY AND METHOD FOR PRODUCING NON-AQUEOUS ELECTROLYTIC SOLUTION SECONDARY BATTERY

(71) Applicant: PANASONIC ENERGY CO., LTD., Moriguchi-shi, Osaka (JP)

(72) Inventors: Katsuhiro Sasayama, Osaka (JP); Atsushi Kaiduka, Osaka (JP)

(73) Assignee: Panasonic Energy Co., Ltd., Moriguchi-shi, Osaka (JP)

(21) Appl. No.: 18/282,865

(22) PCT Filed: Mar. 22, 2022
(86) PCT No.: PCT/JP2022/013052

§ 371 Date: Sep. 19, 2023

(30) Foreign Application Priority Data
Mar. 24, 2021 (JP) 2021-050632

(51) Int. Cl. H01M 10/42; H01M 10/0587; H01M 50/107; H01M 50/121; H01M 50/124

(52) U.S. Cl. CPC H01M 10/4235; H01M 10/0587; H01M 50/107; H01M 50/121; H01M 50/1243

(57) ABSTRACT

This non-aqueous electrolytic solution secondary battery has a wound electrode body in which a positive electrode and a negative electrode are wound with a separator interposed therebetween, a non-aqueous electrolytic solution, and a battery case for accommodating the wound electrode body and the non-aqueous electrolytic solution. The relationship between the elemental nitrogen concentration A1 derived from a dinitrile-group-containing compound in an outermost circumferential surface of the wound electrode body, and the elemental nitrogen concentration B derived from a dinitrile-group-containing compound in an inner region located further inward than the outermost circumferential surface of the wound electrode body, satisfies A1>B.

### TECHNICAL FIELD

The present disclosure relates to a non-aqueous electrolyte secondary battery and a method for manufacturing a non-aqueous electrolyte secondary battery.

### BACKGROUND

In recent years, as a secondary battery having high output and high energy density, a non-aqueous electrolyte secondary battery that includes an electrode assembly in which a positive electrode and a negative electrode are wound with a separator interposed therebetween, and a non-aqueous electrolyte and performs charging and discharging by moving lithium ions and the like between the positive electrode and the negative electrode has been widely used.

For example, Patent Literatures 1 to 4 propose a non-aqueous electrolyte secondary battery using a non-aqueous electrolyte to which a nitrile compound is added.

### CITATION LIST

### Patent Literatures

Patent Literature 1: JP H07-176322 A
Patent Literature 2: JP 2004-179146 A
Patent Literature 3: JP 2010-073367 A
Patent Literature 4: JP 2006-073513 A

### SUMMARY

### Technical Problem

When a nitrile compound is added to the non-aqueous electrolyte, it is possible to suppress elution of metal components of an electrode assembly or a battery case into the non-aqueous electrolyte, but there is a problem that the initial resistance of the non-aqueous electrolyte secondary battery increases.

Therefore, an object of the present disclosure is to provide a non-aqueous electrolyte secondary battery capable of suppressing metal elution into a non-aqueous electrolyte and an increase in initial resistance of the battery, and a method for manufacturing the same. SOLUTION TO PROBLEM

According to an aspect of the present disclosure, a non-aqueous electrolyte secondary battery includes: a wound electrode assembly in which a positive electrode and a negative electrode are wound with a separator interposed therebetween; a non-aqueous electrolyte; and a battery case for housing the wound electrode assembly and the non-aqueous electrolyte, in which a relationship of A1>B is satisfied, in which A1 is a nitrogen element concentration derived from a dinitrile group-containing compound in an outermost circumferential surface of the wound electrode assembly, and B is a nitrogen element concentration derived from a dinitrile group-containing compound in an inner region inside the outermost circumferential surface of the wound electrode assembly.

In addition, according to an aspect of the present disclosure, a non-aqueous electrolyte secondary battery includes: a wound electrode assembly in which a positive electrode and a negative electrode are wound with a separator interposed therebetween; a non-aqueous electrolyte; and a battery case for housing the wound electrode assembly and the non-aqueous electrolyte, in which a relationship of A2>B is satisfied, in which A2 is a nitrogen element concentration derived from a dinitrile group-containing compound in an inner wall of the battery case, and B is a nitrogen element concentration derived from a dinitrile group-containing compound in an inner region inside an outermost circumferential surface of the wound electrode assembly.

In addition, according to an aspect of the present disclosure, a method for manufacturing a non-aqueous electrolyte secondary battery includes: applying a dinitrile group-containing compound to an outermost circumferential surface of a wound electrode assembly in which a positive electrode and a negative electrode are wound with a separator interposed therebetween; and housing, in a battery case, the wound electrode assembly to which the dinitrile group-containing compound is applied and a non-aqueous electrolyte, in which the dinitrile group-containing compound is a compound represented by a chemical formula NC—X—CN (in the formula, X is a C1-C12 aliphatic hydrocarbon group (which may have a heteroatom) or a C6-C20 aromatic hydrocarbon group (which may have a heteroatom)).

In addition, according to an aspect of the present disclosure, a method for manufacturing a non-aqueous electrolyte secondary battery includes: applying a dinitrile group-containing compound to an inner wall of a battery case; and housing, in the battery case to which the dinitrile group-containing compound is applied, a wound electrode assembly in which a positive electrode and a negative electrode are wound with a separator interposed therebetween, and a non-aqueous electrolyte, in which the dinitrile group-containing compound is a compound represented by a chemical formula NC—X—CN (in the formula, X is a C1-C12 aliphatic hydrocarbon group (which may have a heteroatom) or a C6-C20 aromatic hydrocarbon group (which may have a heteroatom)).

### Advantageous Effects of Invention

According to an aspect of the present disclosure, it is possible to provide a non-aqueous electrolyte secondary battery capable of suppressing metal elution into a non-aqueous electrolyte and an increase in initial resistance of the battery, and a method for manufacturing the same.

### BRIEF DESCRIPTION OF DRAWINGS

FIG. 1 is a perspective view illustrating an appearance of a non-aqueous electrolyte secondary battery according to an embodiment.

FIG. 2 is a cross-sectional view of the non-aqueous electrolyte secondary battery taken along line L1-L1 in FIG. 1.

### DESCRIPTION OF EMBODIMENTS

Hereinafter, an example of a non-aqueous electrolyte secondary battery according to an aspect of the present disclosure will be described. The drawings referred to in the description of the following embodiment are schematically illustrated, and dimensional ratios and the like of components drawn in the drawings may be different from actual ones.

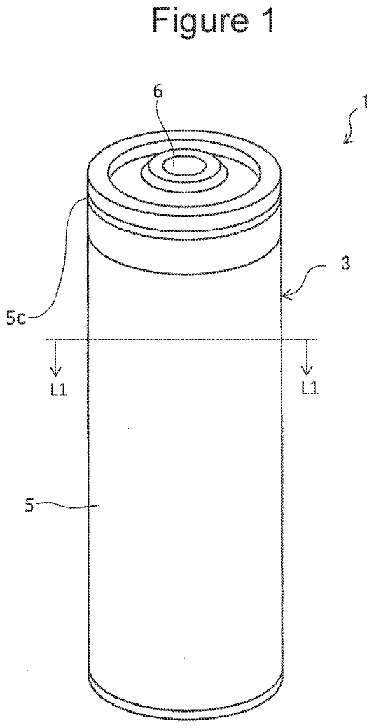

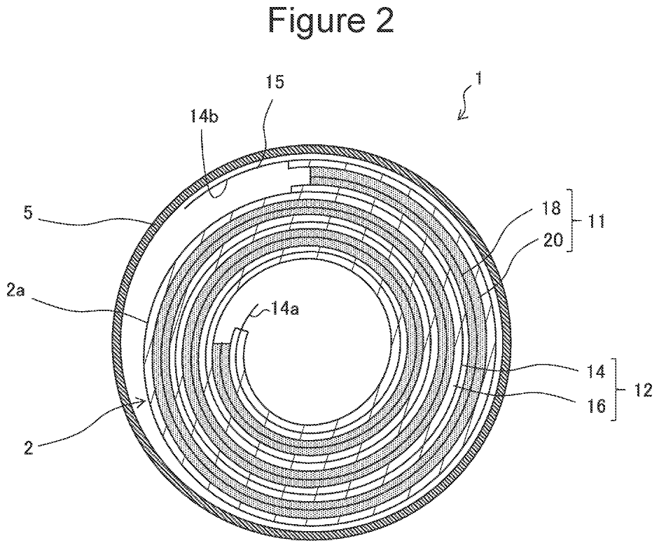

FIG. 1 is a perspective view illustrating an appearance of a non-aqueous electrolyte secondary battery according to an embodiment. FIG. 2 is a cross-sectional view of the non-aqueous electrolyte secondary battery taken along line L1-L1 in FIG. 1.

A non-aqueous electrolyte secondary battery 1 according to the present embodiment includes an electrode assembly 2, a non-aqueous electrolyte (not illustrated), and a battery case 3.

The battery case 3 houses the electrode assembly 2, the non-aqueous electrolyte, and the like, and includes, for example, a case body 5 having an opening and a sealing assembly 6 for sealing the opening of the case body 5. The case body 5 is, for example, a bottomed cylindrical metal outer can, and a groove portion 5c protruding inward along a circumferential direction is formed in an upper portion of the case body 5. The sealing assembly 6 is supported by the groove portion 5c, and seals the opening of the case body 5. A gasket is desirably provided between the case body 5 and the sealing assembly 6 to secure a sealing property of the inside of the battery.

The electrode assembly 2 illustrated in FIG. 2 is a wound electrode assembly in which a positive electrode 11 and a negative electrode 12 are wound with a separator interposed therebetween (hereinafter, referred to as a wound electrode assembly 2). However, in FIG. 2, the separator disposed between the positive electrode 11 and the negative electrode 12 is not illustrated. Although the wound electrode assembly 2 illustrated in FIG. 2 is a cylindrical type, the shape of the wound electrode assembly 2 is not limited thereto, and may be a flat type or the like.

The negative electrode 12 includes a negative electrode current collector 14 and a negative electrode active material layer 16 disposed on the negative electrode current collector 14. Note that the negative electrode active material layer 16 is desirably disposed on both surfaces of the negative electrode current collector 14.

In addition, the negative electrode 12 has negative electrode current collector exposed portions 14a and 14b in which the negative electrode active material layer 16 is not disposed on the negative electrode current collector 14 and the negative electrode current collector 14 is exposed. As illustrated in FIG. 2, the negative electrode current collector exposed portion 14a is positioned on the innermost circumferential side of the electrode assembly 2, and the negative electrode current collector exposed portion 14b is positioned on the outermost circumferential side of the electrode assembly 2. The negative electrode current collector 14 is exposed on a surface 15 on the outer side of the electrode assembly 2 (outer surface) in a radial direction in the negative electrode current collector exposed portion 14b illustrated in FIG. 2 with a length that makes one or more turns from an end of the outer circumferential side of the electrode assembly 2, and forms the outermost circumferential surface 2a of the electrode assembly 2. Note that elements forming the outermost circumferential surface 2a of the electrode assembly 2 are determined according to a design of the electrode assembly 2. For example, when the negative electrode active material layer 16 extends to the outermost circumference of the electrode assembly 2, the surface of the negative electrode active material layer 16 and the outer surface 15 of the negative electrode current collector exposed portion 14b in the extended portion become the outermost circumferential surface 2a of the electrode assembly 2. In addition, when the outermost circumference of the electrode assembly 2 is designed to be the separator, the surface on the outer side of the electrode assembly 2 in the radial direction in the outermost circumference of the separator becomes the outermost circumferential surface 2a of the electrode assembly 2. In addition, when the outermost circumference of the electrode assembly 2 is designed to be the positive electrode 11, the surface on the outer side of the electrode assembly 2 in the radial direction in the outermost circumference of the positive electrode 11 becomes the outermost circumferential surface 2a of the electrode assembly 2.

In the present embodiment, the outer surface 15 of the negative electrode current collector exposed portion 14b becomes the outermost circumferential surface 2a of the electrode assembly 2, but in this case, the outer surface 15 of the negative electrode current collector exposed portion 14b is desirably in contact with an inner wall of the case body 5. Therefore, the case body 5 can be used as a negative electrode terminal. In addition, in the present embodiment, the case body 5 may be used as a negative electrode terminal by a structure in which one end of a negative electrode tab is connected to the negative electrode 12 (for example, the negative electrode current collector exposed portion 14a) and the other end is connected to the case body 5 (for example, a bottom portion) instead of or in combination with a structure in which the outer surface 15 of the negative electrode current collector exposed portion 14b is in contact with the inner wall of the case body 5.

When a non-aqueous electrolyte secondary battery is manufactured, as described below, a dinitrile group-containing compound is applied to the outermost circumferential surface 2a of the electrode assembly 2, or a dinitrile group-containing compound is applied to the inner wall of the battery case 3. Therefore, in the non-aqueous electrolyte secondary battery 1 of the present embodiment, a relationship of A1>B is satisfied, in which A1 is a nitrogen element concentration derived from a dinitrile group-containing compound in the outermost circumferential surface 2a of the electrode assembly 2 (in FIG. 2, the outer surface 15 of the negative electrode current collector exposed portion 14b), and B is a nitrogen element concentration derived from a dinitrile group-containing compound in an inner region inside the outermost circumferential surface 2a of the electrode assembly 2, and/or a relationship of A2>B is satisfied, in which A2 is a nitrogen element concentration derived from a dinitrile group-containing compound in an inner wall of the battery case 3, and B is a nitrogen element concentration derived from a dinitrile group-containing compound in the inner region inside the outermost circumferential surface 2a of the electrode assembly 2. The inner region inside the outermost circumferential surface 2a of the electrode assembly 2 means a region of the electrode assembly 2 inside the outermost circumferential surface 2a of the electrode assembly 2 in the radial direction. In addition, the term “derived from a dinitrile group-containing compound” means a dinitrile group-containing compound itself or a decomposition product of a dinitrile group-containing compound by a charge-discharge reaction or the like. That is, in the present embodiment, the dinitrile group-containing compound or the decomposition product of the dinitrile group-containing compound are present more on the outermost circumferential surface 2a of the electrode assembly 2 and/or the inner wall of the battery case 3 than on the inner region inside the outermost circumferential surface 2a of the electrode assembly 2.

As in the related art, when the dinitrile group-containing compound is added to the non-aqueous electrolyte, the dinitrile group-containing compound decomposes during charging and discharging, and a coating film of a decomposition product of the dinitrile group-containing compound is formed on the outermost circumferential surface 2a or the inner region of the electrode assembly 2, and the inner wall of the battery case 3 or the like. The elution of the metal components of the outermost circumferential surface 2a of the electrode assembly 2 or the battery case 3 into the non-aqueous electrolyte can be suppressed by the coating film. By suppressing the metal elution into the non-aqueous electrolyte, for example, an effect of suppressing deterioration of charge and discharge cycle characteristics and the like can be obtained. However, since the coating film formed on the negative electrode active material layer or the like in the inner region of the electrode assembly 2 becomes a resistance component, the initial resistance of the battery is increased.

On the other hand, as in the non-aqueous electrolyte secondary battery of the present embodiment, when A1, A2, and B satisfy the relationship of A1>B and/or A2>B, the coating film of the decomposition product of the dinitrile group-containing compound formed on the outermost circumferential surface 2a of the electrode assembly 2 or the inner wall of the battery case 3 is large, and the coating film of the decomposition product of the dinitrile group-containing compound formed on the inner region of the electrode assembly 2 is small. In such a state, the metal components of the outermost circumferential surface 2a of the electrode assembly 2 or the battery case 3 are suppressed from eluting into the non-aqueous electrolyte, and furthermore, since it is difficult to form a coating film that becomes a resistance component on the negative electrode active material layer or the like in the inner region of the electrode assembly 2, an increase in initial resistance of the battery is also suppressed.

A ratio (B/A1) of the nitrogen element concentration B derived from the dinitrile group-containing compound in the inner region inside the outermost circumferential surface 2a of the electrode assembly 2 to the nitrogen element concentration A1 derived from the dinitrile group-containing compound in the outermost circumferential surface 2a of the wound electrode assembly 2 is preferably less than or equal to 0.5. In addition, a ratio (B/A2) of the nitrogen element concentration B derived from the dinitrile group-containing compound in the inner region inside the outermost circumferential surface 2a of the electrode assembly 2 to the nitrogen element concentration A2 derived from the dinitrile group-containing compound in the inner wall of the battery case 3 is preferably less than or equal to 0.5. When the above range is satisfied, metal elution into the non-aqueous electrolyte may be suppressed or an increase in initial resistance of the battery may be suppressed as compared with a case where the above range is not satisfied.

The nitrogen element concentration A1 derived from the dinitrile group-containing compound on the outermost circumferential surface 2a of the electrode assembly 2 or the nitrogen element concentration A2 derived from the dinitrile group-containing compound on the inner wall of the battery case 3 is, for example, preferably in a range of 2 to 20 atom %, and more preferably in a range of 2 to 10 atom %, from the viewpoint of suppressing metal elution into the non-aqueous electrolyte. In addition, the nitrogen element concentration B derived from the dinitrile group-containing compound in the inner region inside the outermost circumferential surface 2a of the electrode assembly 2 is, for example, preferably less than or equal to 1 atom %, and preferably zero, from the viewpoint of suppressing an increase in initial resistance of the battery. See the section of Examples for the method for measuring the nitrogen element concentration derived from the dinitrile group-containing compound.

Examples of the negative electrode current collector 14 include a foil of a metal stable in a potential range of the negative electrode 12, such as copper, and a film in which the metal is disposed on a surface layer.

The negative electrode active material layer 16 contains, for example, a negative electrode active material, a binder material, and the like.

The negative electrode active material is not particularly limited as long as it is a material capable of occluding and releasing lithium ions, and for example, a carbon material such as graphite, non-graphitizable carbon, graphitizable carbon, fibrous carbon, coke, or carbon black, a metal alloyed with Li, such as Si or Sn, a metal compound containing Si, Sn, and the like, a lithium-titanium composite oxide, and the like may be used. From the viewpoint of increasing a capacity of the battery, the negative electrode active material preferably contains, for example, a carbon material and a Si material, and a ratio of the Si compound to the total mass of the negative electrode active material is preferably greater than or equal to 5.5 mass %. Examples of the Si material include SiOₓ (0.5≤x≤1.6).

Examples of the binder material include a fluorine-based resin, polyacrylonitrile (PAN), a polyimide-based resin, an acrylic resin, a polyolefin-based resin, styrene-butadiene rubber (SBR), nitrile-butadiene rubber (NBR), carboxymethyl cellulose (CMC) or a salt thereof, polyacrylic acid (PAA) or a salt thereof (PAA-Na, PAA-K, and the like, or a partially neutralized salt may be used), and polyvinyl alcohol (PVA). These binder materials may be used alone or in combination of two or more thereof.

The negative electrode 12 can be manufactured by preparing a negative electrode mixture slurry containing a negative electrode active material, a binder material, and the like, applying the negative electrode mixture slurry onto the negative electrode current collector 14, performing drying to form the negative electrode active material layer 16, and rolling the negative electrode active material layer.

The positive electrode 11 includes a positive electrode current collector 18 and a positive electrode active material layer 20 disposed on the positive electrode current collector 18. As illustrated in FIG. 2, the positive electrode active material layer 20 is desirably disposed on both surfaces of the positive electrode current collector 18. Note that, although not illustrated in the drawings, the positive electrode 11 has a positive electrode current collector exposed portion in which the positive electrode active material layer 20 is not disposed on the positive electrode current collector 18, and the positive electrode current collector 18 is exposed. One end of a positive electrode tab is connected to the positive electrode current collector exposed portion, and the other end is connected to an inner wall of the sealing assembly 6. Accordingly, the sealing assembly 6 becomes a terminal of the positive electrode 11.

As the positive electrode current collector 18, a foil of a metal stable in a potential range of the positive electrode 11, such as aluminum, a film in which the metal is disposed on a surface layer, or the like can be used.

The positive electrode active material layer 20 contains, for example, a positive electrode active material, a binder material, a conductive agent, and the like.

Examples of the positive electrode active material include lithium transition metal oxides containing transition metal elements such as Co, Mn, and Ni. The lithium transition metal oxide is, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, or Li₂MPO₄F (M; at least one of Na, Mg, Sc, Y, Mn, Fe, Co, Ni, Cu, Zn, Al, Cr, Pb, Sb, and B, 0<x≤1.2, 0<y≤0.9, 2.0≤z≤2.3). These lithium transition metal oxides may be used alone or in combination of a plurality of kinds thereof. From the viewpoint that a high capacity of the battery can be achieved, it is desirable that the positive electrode active material contains a lithium nickel composite oxide such as LiₓNiO₂, LiₓCo_{y}Ni_{1-y}O₂, or LiₓNi_{1-y}M_{y}O_{z} (M; at least one of Na, Mg, Sc, Y, Mn, Fe, Co, Ni, Cu, Zn, Al, Cr, Pb, Sb, and B, 0<x≤1.2, 0<y≤0.9, 2.0≤z≤2.3).

Examples of the conductive agent include carbon-based particles such as carbon black (CB), acetylene black (AB), Ketjenblack, and graphite. These conductive agents may be used alone or in combination of two or more thereof.

Examples of the binder material include a fluorine-based resin such as polytetrafluoroethylene (PTFE) or polyvinylidene fluoride (PVdF), polyacrylonitrile (PAN), a polyimide-based resin, an acrylic resin, and a polyolefin-based resin. These conductive agents may be used alone or in combination of two or more thereof.

The positive electrode 11 can be manufactured, for example, by applying a positive electrode mixture slurry containing a positive electrode active material, a binder material, a conductive agent, and the like on the positive electrode current collector 18, performing drying to form the positive electrode active material layer 20, and then rolling the positive electrode active material layer 20.

For example, a porous sheet having an ion permeation property and an insulation property is used for the separator. Specific examples of the porous sheet include a fine porous thin film, a woven fabric, and a non-woven fabric. As a material of the separator, an olefin-based resin such as polyethylene or polypropylene, cellulose, and the like are preferable. The separator may be a laminate including a cellulose fiber layer and a thermoplastic resin fiber layer formed of an olefin-based resin or the like. In addition, a multi-layer separator including a polyethylene layer and a polypropylene layer may be used, or a separator obtained by applying a material such as an aramid-based resin or ceramic to a surface of the separator may be used.

The non-aqueous electrolyte contains an electrolyte salt and a non-aqueous solvent that dissolves the electrolyte salt. The electrolyte salt is preferably a lithium salt. Examples of the lithium salt include borates such as LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CnF₂ₙ₊₁)ₓ (1<x<6, n is 1 or 2), LiB₁₀Cl₁₀, LiCl, LiBr, LiI, lithium chloroborane, lithium lower aliphatic carboxylate, Li₂B₄O₇, and Li(B(C₂O₄)F₂), and imide salts such as LiN(SOdCF₃)₂ and LiN(C₁F₂₁₊₁SO₂)(CₘF₂ₘ₊₁SO₂) {1 and m are integers greater than or equal to 0}. These lithium salts may be used alone or in combination of a plurality of kinds thereof. Among them, LiPF₆ is preferably used from the viewpoint of ion conductivity, electrochemical stability, and the like. A concentration of the lithium salt is preferably greater than or equal to 0.8 mol and less than or equal to 1.8 mol per 1 L of the non-aqueous solvent.

As the non-aqueous solvent, for example, esters, ethers, nitriles such as acetonitrile, amides such as dimethylformamide, a mixed solvent of two or more thereof, and the like can be used. The non-aqueous solvent may contain a halogen-substituted product in which at least some hydrogens in these solvents are substituted with halogen atoms such as fluorine.

Examples of the esters include cyclic carbonates such as ethylene carbonate (EC), propylene carbonate (PC), and butylene carbonate, chain carbonates such as dimethyl carbonate (DMC), ethyl methyl carbonate (EMC), diethyl carbonate (DEC), methyl propyl carbonate, ethyl propyl carbonate, and methyl isopropyl carbonate, cyclic carboxylic acid esters such as γ-butyrolactone and γ-valerolactone, and chain carboxylic acid esters such as methyl acetate, ethyl acetate, propyl acetate, methyl propionate (MP), and ethyl propionate.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ether, and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted product, fluorinated cyclic carbonate ester such as fluoroethylene carbonate (FEC), fluorinated chain carboxylic acid ester such fluorinated chain carbonate ester or methyl fluoropropionate (FMP), and the like are preferably used.

The method for manufacturing a non-aqueous electrolyte secondary battery according to the present embodiment includes: applying a dinitrile group-containing compound to an outermost circumferential surface 2a of a wound electrode assembly 2 (in FIG. 2, an outer surface 15 of a negative electrode current collector exposed portion 14b) in which a positive electrode 11 and a negative electrode 12 are wound with a separator interposed therebetween; and housing, in a battery case 3, the wound electrode assembly 2 to which the dinitrile group-containing compound is applied and a non-aqueous electrolyte. The manufacturing method of the present embodiment may include applying a dinitrile group-containing compound to an inner wall of the battery case 3 before housing, in the battery case 3, the wound electrode assembly 2 to which the dinitrile group-containing compound is applied and the non-aqueous electrolyte. By charging and discharging the non-aqueous electrolyte secondary battery obtained by the manufacturing method of the present embodiment, a non-aqueous electrolyte secondary battery satisfying a relationship of A1>B is obtained, in which A1 is a nitrogen element concentration derived from a dinitrile group-containing compound in an outermost circumferential surface 2a of the wound electrode assembly 2, and B is a nitrogen element concentration derived from a dinitrile group-containing compound in an inner region inside the outermost circumferential surface of 2a the wound electrode assembly 2.

The method for manufacturing a non-aqueous electrolyte secondary battery according to the present embodiment include: applying a dinitrile group-containing compound to the inner wall of the battery case 3; and housing, in the battery case 3 to which the dinitrile group-containing compound is applied, the wound electrode assembly 2 in which the positive electrode 11 and the negative electrode 12 are wound with the separator interposed therebetween and the non-aqueous electrolyte. In the manufacturing method of the present embodiment, the dinitrile group-containing compound may include, before the housing of the wound electrode assembly 2 and the non-aqueous electrolyte in the battery case 3 to which the dinitrile group-containing compound is applied, applying a dinitrile group-containing compound to the outermost circumferential surface 2a of the wound electrode assembly 2 (in FIG. 2, the outer surface 15 of the negative electrode current collector exposed portion 14b). By charging and discharging the non-aqueous electrolyte secondary battery obtained by the manufacturing method of the present embodiment, a non-aqueous electrolyte secondary battery satisfying a relationship of A2>B is obtained, in which A2 is a nitrogen element concentration derived from a dinitrile group-containing compound in the inner wall of the battery case 3, and B is a nitrogen element concentration derived from a dinitrile group-containing compound in an inner region inside the outermost circumferential surface of 2a the wound electrode assembly 2.

In the manufacturing method, it is preferable that the dinitrile group-containing compound is not applied to the inner region inside the outermost circumferential surface 2a of the wound electrode assembly 2. However, when the dinitrile group-containing compound is applied to the inner region inside the outermost circumferential surface 2a of the wound electrode assembly 2, the amount of the dinitrile group-containing compound applied is preferably smaller than the amount of the dinitrile group-containing compound applied to the outermost circumferential surface 2a of the wound electrode assembly 2.

In the manufacturing method, when the dinitrile group-containing compound is applied to the inner wall of the battery case 3, the dinitrile group-containing compound may be applied to both the inner wall of the case body 5 and the inner wall of the sealing assembly 6, but it is preferable to apply the dinitrile group-containing compound to at least the inner wall of the case body 5. This is because the metal of the case body 5 in contact with the non-aqueous electrolyte is easily eluted.

The dinitrile group-containing compound used in the manufacturing method is not particularly limited as long as it is a compound having two nitrile groups in one molecule, and for example, from the viewpoint of effectively suppressing metal elution, it is preferable to include a compound represented by a chemical formula NC—X—CN (in the formula, X is a C1-C12 aliphatic hydrocarbon group (which may have a heteroatom) or a C6-C20 aromatic hydrocarbon group (which may have a heteroatom)). The aliphatic hydrocarbon group may be either chain or cyclic, and the chain aliphatic hydrocarbon group may be either linear or branched.

The number of carbon atoms of the aliphatic hydrocarbon group is, for example, preferably in a range of C1 to C12, and more preferably, in a range of C2 to C10, from the viewpoint of effectively suppressing metal elution into the non-aqueous electrolyte. In addition, the number of carbon atoms of the aromatic hydrocarbon group is, for example, preferably in a range of C6 to C20, and more preferably, in a range of C8 to C18, from the viewpoint of effectively suppressing metal elution into the non-aqueous electrolyte.

Examples of the aliphatic hydrocarbon group include an alkyl group, an alkenyl group, and an alkynyl group. Examples of the aromatic hydrocarbon group include a phenyl group, a tolyl group, a benzyl group, and a phenethyl group.

The aliphatic hydrocarbon group or the aromatic hydrocarbon group may have a heteroatom substituted with a hydrogen atom or a carbon atom. The heteroatom is not particularly limited, and examples thereof include boron, silicon, nitrogen, sulfur, fluorine, chlorine, and bromine.

Examples of the dinitrile group-containing compound include adiponitrile, succinonitrile, glutaronitrile, malononitrile, pimelonitrile, suberonitrile, azelanitrile, sebaconitrile, undecane dinitrile, dodecane dinitrile, fumaronitrile, 3-hexenedinitrile, maleonitrile, 1,12-dicyanododecane, tetramethylsuccinonitrile, 2-methylglutaronitrile, 2,4-dimethyl glutaronitrile, 2,2,4,4-tetramethyl glutaronitrile, 1,4-dicyanopentane, 2,5-dimethyl-2,5-hexane dicarbonitrile, 2,6-dicyanoheptane, 2,7-dicyanooctane, 2,8-dicyanononane, 1,6-dicyanodecane, methyl malononitrile, ethyl malononitrile, isopropyl malononitrile, tert-butyl malononitrile, methyl succinonitrile, 2,2-dimethyl succinonitrile, 2,3-dimethyl succinonitrile, trimethyl succinonitrile, tetramethyl succinonitrile, 3,3′-oxydipropionitrile, 3,3′-thiodipropionitrile, 3,3′-(ethylenedioxy)dipropionitrile, 3,3′-(ethylenedithio)dipropionitrile, 1,2-benzodinitrile, 1,3-benzodinitrile, 1,4-benzodinitrile, 1,2-dicyanocyclobutane, 1,1-dicyanoethyl acetate, 2,3-dicyanohydroquinone, 4,5-dicyanoimidazole, 2,4-dicyano-3-methylglutamide, 9-dicyanomethylene-2,4,7-trinitrofluorene, and 2,6-dicyanotoluene. These dinitrile group-containing compounds may be used alone or in combination of two or more thereof.

### EXAMPLES

Hereinafter, the present disclosure will be further described with reference to Examples, but the present disclosure is not limited to these Examples.

### EXAMPLES

### Manufacture of Positive Electrode

As a positive electrode active material, an aluminum-containing lithium nickel cobalt oxide (LiNi_{0.88}Co_{0.09}Al_{0.03}O₂) was used. 100 parts by mass of the positive electrode active material, 1 part by mass of acetylene black, and 0.9 parts by mass of polyvinylidene fluoride were mixed in a solvent of N-methyl-2-pyrrolidone (NMP), thereby preparing a positive electrode mixture slurry. The slurry was applied to both surfaces of an aluminum foil having a thickness of 15 μm, the coating film was dried, and then the dried coating film was rolled by a rolling roller, thereby manufacturing a positive electrode in which a positive electrode active material layer was formed on both surfaces of a positive electrode current collector. The manufactured positive electrode was cut to a width of 57.6 mm and a length of 679 mm and used.

### Manufacture of Negative Electrode

As a negative electrode active material, a mixture obtained by mixing 95 parts by mass of graphite powder and 5 parts by mass of Si oxide was used. 100 parts by mass of the negative electrode active material, 1 part by mass of carboxymethyl cellulose (CMC), and 1 part by mass of styrene-butadiene rubber (SBR) were dispersed in water, thereby preparing a negative electrode mixture slurry. The slurry was applied to both surfaces of a copper foil having a thickness of 8 μm, the coating film was dried, and then the dried coating film was rolled by a rolling roller, thereby manufacturing a negative electrode in which a negative electrode active material layer was formed on both surfaces of a negative electrode current collector. The manufactured negative electrode was cut to a width of 58.6 mm and a length of 662 mm and used.

### Preparation of Non-Aqueous Electrolyte

To a non-aqueous solvent obtained by mixing ethylene carbonate (EC), methyl ethyl carbonate (MEC), and dimethyl carbonate (DMC) at a volume ratio of 20:5:75, LiPF₆ was dissolved at a concentration of 1.4 mol/L, and 3 mass % of vinylene carbonate (VC) was added, thereby preparing a non-aqueous electrolyte.

### Manufacture of Non-Aqueous Electrolyte Secondary Battery

An aluminum positive electrode lead was attached to a positive electrode current collector, a nickel-copper-nickel negative electrode lead was attached to a negative electrode current collector, and then, a positive electrode and a negative electrode were wound with a polyethylene separator interposed therebetween, thereby manufacturing a wound electrode assembly. Adiponitrile was applied to the negative electrode current collector exposed portion as the outermost circumferential surface of the electrode assembly in an amount of 0.1 mass % with respect to the mass of the non-aqueous electrolyte to be injected, by a brush coating method. Insulating plates were disposed on upper and lower sides of the wound electrode assembly, respectively, the negative electrode lead was welded to a case body, the positive electrode lead was welded to a sealing assembly, and the electrode assembly was housed in the case body. Then, the non-aqueous electrolyte was injected into a case body by a pressure reduction method, and then an end of an opening of the case body was sealed with a sealing assembly with a gasket, thereby manufacturing a non-aqueous electrolyte secondary battery. The battery capacity was 3,300 mAh.

### Comparative Example 1

A non-aqueous electrolyte secondary battery was manufactured in the same manner as in Example, except that adiponitrile was not applied to the outer circumferential surface of the wound electrode assembly.

### Comparative Example 2

A non-aqueous electrolyte secondary battery was manufactured in the same manner as in Example, except that adiponitrile was not applied to the outer circumferential surface of the wound electrode assembly, and 0.1 mass % of adiponitrile was added to the non-aqueous electrolyte of Example.

### Comparative Example 3

A non-aqueous electrolyte secondary battery was manufactured in the same manner as in Example, except that adiponitrile was not applied to the outer circumferential surface of the wound electrode assembly, and 1 mass % of adiponitrile was added to the non-aqueous electrolyte of Example.

### Method for Measuring Eluted Fe Concentration

The non-aqueous electrolyte secondary battery of each of Example and Comparative Examples was allowed to stand in an environment of 25° C. for 24 hours, a hole was made in the battery case, and then the non-aqueous electrolyte inside the non-aqueous electrolyte secondary battery was extracted with a centrifuge. Nitric acid was added to the extracted non-aqueous electrolyte and diluted to obtain a measurement sample. The amount (μg) of Fe in the measurement sample was measured by an inductively coupled plasma (ICP) emission spectrophotometer, and the amount (μg/g) of Fe per mass of the non-aqueous electrolyte was taken as an eluted Fe concentration. The lower the value is, the more the metal elution into the non-aqueous electrolyte is suppressed.

### Measurement of Initial Resistance

Each of the non-aqueous electrolyte secondary battery of each of Example and Comparative Examples was subjected to constant current charge up to 4.2 V at a constant current of 990 mA (0.3 It) and an environmental temperature of 25° C., and then was subjected to constant voltage charge at a constant voltage of 4.2 V and a termination current of 66 mA, thereby adjusting the state of charge (SOC) to 100%. Then, an alternating current impedance was measured at an environmental temperature of 25° C., a resistance value at 1 kHz was measured, and the measured resistance value was taken as an initial resistance.

### Measurement of Nitrogen Element Concentration Derived from Dinitrile Group-Containing Compound

Each battery of which the initial resistance was measured was subjected to constant current discharge up to 3.0 V at a constant current of 1,650 mA (0.5 It) and an environmental temperature of 25° C., each battery was disassembled in an argon gas atmosphere, the negative electrode current collector exposed portion, which was the outermost circumferential surface of the electrode assembly was cut out, the negative electrode on the innermost circumferential surface of the electrode assembly (winding core center portion of the electrode assembly) was cut out, each of the negative electrode current collector exposed portion and the negative electrode was introduced into an X-ray photoelectron analyzer (ESCA) in a state of not being brought into contact with the atmosphere, and then a nitrogen element concentration was measured. The nitrogen element concentration measured at this time is a nitrogen element concentration in the coating film of the decomposition product of a dinitrile group-containing compound or the like. A nitrogen element concentration ratio (B/A) was calculated by setting the measured nitrogen element concentration on the outermost circumferential surface of the electrode assembly as a nitrogen element concentration A derived from a dinitrile group-containing compound on the outermost circumferential surface of the electrode assembly and the measured nitrogen element concentration of the negative electrode in the innermost circumferential surface of the electrode assembly as a nitrogen element concentration B derived from a dinitrile group-containing compound in the inner region of the electrode assembly. Note that, in the measurement of the nitrogen element concentration in the inner region of the electrode assembly, when it is known that the dinitrile group-containing compound is not contained in the battery, any one location in the inner region of the electrode assembly may be used as the measurement location. In addition, when it is unknown whether or not the dinitrile group-containing compound is contained in the battery, it is required to set a plurality of locations (preferably 10 to 15 locations) in the inner region of the electrode assembly as the measurement locations. Then, the maximum nitrogen element concentration among the measurement locations in the inner region of the electrode assembly is adopted.

Table 1 summarizes the results of the eluted Fe concentration, initial resistance, and nitrogen element concentration ratio (B/A) of each of Example and Comparative Examples.

TABLE 1

| | | Eluted Fe | Initial | Nitrogen element |
|---|---|---|---|---|
| | | concentration | resistance | concentration |
| | Adiponitrile | (μg/g) | (Ω) | ratio B/A |
| Example | Applied to outermost | <1 | 0.0191 | <0.25 |
| | circumferential surface | | | |
| | of electrode assembly | | | |
| Comparative | None | 5.6 | 0.0191 | — |
| Example 1 | | | | |
| Comparative | Added to electrolyte | 3.3 | 0.0194 | 1 |
| Example 2 | (0.1 mass %) | | | |
| Comparative | Added to electrolyte | 1.4 | 0.0210 | 1 |
| Example 3 | (1 mass %) | | | |

As shown in Table 1, the initial resistance of Example was equivalent to that of Comparative Example 1, and was lower than those of Comparative Examples 2 and 3. In addition, the eluted Fe concentration of Example was lower than those of Comparative Examples 1 to 3. Therefore, according to Examples, it can be said that the metal elution into the non-aqueous electrolyte was suppressed, and the initial resistance of the battery was also suppressed.

### REFERENCE SIGNS LIST

1 Non-aqueous electrolyte secondary battery
2 Electrode assembly (wound electrode assembly)
2a Outermost circumferential surface
3 Battery case
5 Case body
5c Groove
6 Sealing assembly
11 Positive electrode
12 Negative electrode
14 Negative electrode current collector
14a, 14b Negative electrode current collector exposed portion
15 Outer surface
16 Negative electrode active material layer
18 Positive electrode current collector
20 Positive electrode active material layer

1. A non-aqueous electrolyte secondary battery comprising:
a wound electrode assembly in which a positive electrode and a negative electrode are wound with a separator interposed therebetween;
a non-aqueous electrolyte; and
a battery case for housing the wound electrode assembly and the non-aqueous electrolyte,
wherein a relationship of A1>B is satisfied, in which A1 is a nitrogen element concentration derived from a dinitrile group-containing compound in an outermost circumferential surface of the wound electrode assembly, and B is a nitrogen element concentration derived from a dinitrile group-containing compound in an inner region inside the outermost circumferential surface of the wound electrode assembly.

2. A non-aqueous electrolyte secondary battery comprising:
a wound electrode assembly in which a positive electrode and a negative electrode are wound with a separator interposed therebetween;
a non-aqueous electrolyte; and
a battery case for housing the wound electrode assembly and the non-aqueous electrolyte,
wherein a relationship of A2>B is satisfied, in which A2 is a nitrogen element concentration derived from a dinitrile group-containing compound in an inner wall of the battery case, and B is a nitrogen element concentration derived from a dinitrile group-containing compound in an inner region inside an outermost circumferential surface of the wound electrode assembly.

3. The non-aqueous electrolyte secondary battery according to claim 1, wherein a ratio (B/A1) of the nitrogen element concentration B in the inner region of the wound electrode assembly to the nitrogen element concentration A1 in the outermost circumferential surface of the wound electrode assembly is less than or equal to 0.5.

4. The non-aqueous electrolyte secondary battery according to claim 2, wherein a ratio (B/A2) of the nitrogen element concentration B in the inner region of the wound electrode assembly to the nitrogen element concentration A2 in the inner wall of the battery case is less than or equal to 0.5.

5. The non-aqueous electrolyte secondary battery according to claim 1, wherein the dinitrile group-containing compound is a compound represented by a chemical formula NC—X—CN (in the formula, X is a C1-C12 aliphatic hydrocarbon group (which may have a heteroatom) or a C6-C20 aromatic hydrocarbon group (which may have a heteroatom)).

6. A method for manufacturing a non-aqueous electrolyte secondary battery, the method comprising:
applying a dinitrile group-containing compound to an outermost circumferential surface of a wound electrode assembly in which a positive electrode and a negative electrode are wound with a separator interposed therebetween; and
housing, in a battery case, the wound electrode assembly to which the dinitrile group-containing compound is applied and a non-aqueous electrolyte,
wherein the dinitrile group-containing compound is a compound represented by a chemical formula NC—X—CN (in the formula, X is a C1-C12 aliphatic hydrocarbon group (which may have a heteroatom) or a C6-C20 aromatic hydrocarbon group (which may have a heteroatom)).

7. A method for manufacturing a non-aqueous electrolyte secondary battery, the method comprising:
applying a dinitrile group-containing compound to an inner wall of a battery case; and
housing, in the battery case to which the dinitrile group-containing compound is applied, a wound electrode assembly in which a positive electrode and a negative electrode are wound with a separator interposed therebetween, and a non-aqueous electrolyte,
wherein the dinitrile group-containing compound is a compound represented by a chemical formula NC—X—CN (in the formula, X is a C1-C12 aliphatic hydrocarbon group (which may have a heteroatom) or a C6-C20 aromatic hydrocarbon group (which may have a heteroatom)).
